(19) United States
(12) Patent Application Publication
(10) Pub. No.: US 2026/0212514 A1
(43) Pub. Date: Jul. 23, 2026

(54) METHOD AND SYSTEM FOR END-TO-END OBJECT DETECTION AND TRACKING USING TRANSFORMERS

(71) Applicant: Rivian IP Holdings, LLC, Irvine, CA (US)

(72) Inventors: Yu ZHU, San Jose, CA (US); Vinay PALAKKODE, Santa Clara, CA (US); Nicholas David CARLEVARIS-BIANCO, Los Gatos, CA (US)

(21) Appl. No.: 19/450,395

(22) Filed: Jan. 15, 2026

Related U.S. Application Data
(60) Provisional application No. 63/746,698, filed on Jan. 17, 2025.

(51) Int. Cl. G06T 7/292; G06V 10/80; G06V 20/58

(52) U.S. Cl. CPC G06T 7/292; G06V 10/803; G06V 20/58; G06T 2207/20084; G06V 2201/07

(57) ABSTRACT

Object detection and tracking includes receiving first imaging data from the one or more first imaging sensors and receiving second imaging data from the one or more second imaging sensors. The first imaging data is processed with one or more first stages to transform the first imaging data into first embeddings in a common coordinate system. The second imaging data is processed with one or more second stages to transform the second imaging data into second embeddings in the common coordinate system. The first embeddings are fused by an encoder with the second embeddings to obtain third embeddings. The third embeddings are processed with a transformer-based machine learning tracker to obtain tracks for one or more objects represented in the first imaging data and the second imaging data.

### RELATED APPLICAITONS

This application claims the benefit of U.S. Provisional Application Serial No. 63/746,698, filed January 17, 2025, and entitled METHOD AND SYSTEM FOR END-TO-END OBJECT DETECTION AND TRACKING USING TRANSFORMERS, which is hereby incorporated herein by reference in its entirety.

### INTRODUCTION

The present disclosure relates to object detection and tracking using a machine learning model, such as a transformer.

### SUMMARY

The present disclosure relates to object detection and tracking using a machine learning model. In one aspect, a system includes or more first imaging sensors mounted to a vehicle and implementing a first imaging modality; one or more second imaging sensors mounted to the vehicle and implementing a second imaging modality; and a computing device. The computing device is configured to: receive first imaging data from the one or more first imaging sensors; receive second imaging data from the one or more second imaging sensors; process the first imaging data with one or more first stages to transform the first imaging data into first embeddings in a common coordinate system; process the second imaging data with one or more second stages to transform the second imaging data into second embeddings in the common coordinate system; and fuse the first embeddings and the second embeddings with an encoder to obtain third embeddings representing a 3D scene including objects represented in first and second imaging data.

In some embodiments, the one or more first imaging sensors include one or more cameras. In some embodiments, the one or more cameras include a plurality of cameras, and wherein processing the first imaging data with the one or more first stages comprises separately processing an image from each camera of the plurality of cameras using a stage of the one or more first stages.

In some embodiments, the one or more second imaging sensors include one or more radar sensors. In some embodiments, the one or more radar sensors include a plurality of radar sensors, and wherein processing the second imaging data with the one or more second stages comprises separately processing a set of radar points from each radar sensor of the plurality of radar sensors using a stage of the one or more second stages.

In some embodiments, fusing the first embeddings and the second embeddings with the encoder to obtain the third embeddings comprises processing the first embeddings and the second embeddings for a current time step along with the third embeddings for one or more prior time steps.

In some embodiments, the common coordinate system is one in which X and Y directions are defined in a horizontal plane of the vehicle and a Z direction is perpendicular to the X and Y directions.

In some embodiments, the one or more first stages include a combination of a residual neural network (ResNet) feature extractor and a Lift-Splat-Shoot (LSS) feature pyramid network (FPN).

In some embodiments, the encoder is configured to process the first and second embeddings for a current time step and for at least one preceding time step.

In some embodiments, the computing device is further configured to process the third embeddings with a transformer-based machine learning tracker to obtain tracks for one or more objects represented in the first imaging data and the second imaging data.

In another aspect, a method includes: receiving, by a computing device, first imaging data from one or more first imaging sensors; receiving, by the computing device, second imaging data from one or more second imaging sensors; processing, by the computing device, the first imaging data with one or more first stages to transform the first imaging data into first embeddings in a common coordinate system; processing, by the computing device, the second imaging data with one or more second stages to transform the second imaging data into second embeddings in the common coordinate system; fusing, by the computing device, the first embeddings and the second embeddings with an encoder to obtain third embeddings; and processing, by the computing device, the third embeddings with a transformer-based machine learning tracker to obtain tracks for one or more objects represented in the first imaging data and the second imaging data.

In some embodiments, the method further includes: generating, by the transformer-based machine learning tracker, a query for each time step; and processing, by the transformer-based machine learning tracker, as an input for a time step, the query for a preceding time step.

In some embodiments, the method further includes decoupling, by the transformer-based machine learning tracker, object identification for the one or more objects from obtaining the tracks for the one or more objects.

In some embodiments, the transformer-based machine learning tracker implements three-dimensional multi-camera tracking (MUTR3D). In some embodiments, the transformer-based machine learning tracker implements a DQTrack framework.

In some emboidments, processing the third embeddings with the transformer-based machine learning tracker comprises: generating a track state for a current time step by the transformer-based machine learning tracker based on a track state from one or more preceding time steps and the third embeddings; and processing the track state of the current time step to obtain the tracks.

In some embodiments, fusing the first embeddings and the second embeddings with the encoder to obtain the third embeddings comprises processing the first embeddings and the second embeddings for the current time step with the third embeddings for the one or more preceding time steps.

In another aspect, a system includes: one or more first imaging sensors mounted to a vehicle and implementing a first imaging modality; one or more second imaging sensors mounted to the vehicle and implementing a second imaging modality; and a computing device. The computing device is configured to: receive first imaging data from the one or more first imaging sensors; receive second imaging data from the one or more second imaging sensors; process the first imaging data with one or more first stages to transform the first imaging data into first embeddings in a common coordinate system; process the second imaging data with one or more second stages to transform the second imaging data into second embeddings in the common coordinate system; process the first embeddings and the second embeddings to obtain tracks for one or more objects represented in the first imaging data and the second imaging data; and autonomously altering a trajectory of the vehicle according to the tracks.

In some embodiments, the one or more first imaging sensors include a plurality of cameras, and wherein processing the first imaging data with the one or more first stages comprises separately processing an image from each camera of the plurality of cameras using a stage of the one or more first stages. In some embodiments, the one or more second imaging sensors include one or more radar sensors.

### BRIEF DESCRIPTION OF THE DRAWINGS

FIG. 1A illustrates an example vehicle in accordance with certain embodiments.

FIG. 1B illustrates a chassis of a vehicle in accordance with certain embodiments.

FIG. 2A is a schematic block diagram of a control system of a vehicle in accordance with certain embodiments.

FIG. 2B is a schematic block diagram of an alternative control system of a vehicle in accordance with certain embodiments.

FIG. 3 illustrates a birds-eye view of a vehicle showing the fields of view of sensors of the vehicle in accordance with certain embodiments.

FIGS. 4A to 4D illustrate systems and methods for performing object detection and tracking using transformers in accordance with certain embodiments.

### DETAILED DESCRIPTION

Existing vehicle perception pipelines that perform object detection and multi-object tracking across heterogeneous sensing modalities often encounter technical limitations that degrade tracking accuracy and stability in dynamic driving environments. For example, camera-derived feature maps are typically generated in image coordinate frames, while radar returns are produced in sensor-centric coordinate systems, leading to coordinate misalignment between camera feature representations and radar returns when the outputs are fused downstream. Conventional fusion strategies that operate on late-stage detections or loosely aligned features can therefore introduce false positives from camera-only appearance cues or radar-only noise, particularly in cluttered scenes. In addition, tracking systems that rely on frame-by-frame data association frequently suffer from identity switches during occlusion or cross-camera transitions, track fragmentation when objects temporarily disappear and reappear, and latency or compute bottlenecks caused by repeated pairwise association across large numbers of detections at each time step.

The systems and methods disclosed herein address these technical shortcomings by implementing an end-to-end, transformer-based perception architecture that performs early fusion and temporal tracking in a common vehicle-referenced coordinate system. In particular, first imaging data from one or more cameras is processed by camera-specific encoding stages that extract features and apply a birds-eye-view (BEV) transformation to generate first embeddings aligned to a BEV coordinate system defined with respect to the vehicle. Second imaging data from one or more radar sensors is processed by radar-specific pre-processing and encoding stages to generate second embeddings that are likewise represented in the same BEV coordinate system. By transforming heterogeneous sensor outputs into BEV-consistent embeddings prior to fusion, the disclosed architecture reduces coordinate-frame mismatch, enforces spatial consistency across modalities, and mitigates drift that can arise when camera and radar data are combined in incompatible reference frames.

A BEV encoder then fuses the BEV-aligned camera embeddings and radar embeddings to generate third embeddings representing a unified three-dimensional scene. Unlike late fusion on detected objects, this encoder operates directly on intermediate embeddings and is trained to preserve complementary modality-specific information, such as camera appearance cues and radar range or motion characteristics, within a shared spatial representation. This approach reduces false positives associated with single-modality inference and improves robustness in environments with occlusion, poor lighting, or sparse radar returns.

To further improve temporal consistency and tracking stability, the disclosed architecture incorporates prior time-step information directly into the fusion and tracking process. In some embodiments, the BEV encoder processes current-time-step embeddings together with BEV embeddings generated for one or more preceding time steps, thereby maintaining continuity of the spatial scene representation over time. In addition, a transformer-based machine learning tracker generates and updates object queries and track queries that encode both current object observations and prior track state. By using prior track queries to guide attention toward regions of space associated with previously tracked objects, the tracker reduces identity switches during occlusion and cross-camera transitions and mitigates track fragmentation when objects reappear after temporary loss.

In contrast to tracking pipelines that recompute object-to-track associations from scratch at each frame, the disclosed tracker reuses encoded track state from preceding time steps to inform association and update operations. This reuse of prior track embeddings reduces association complexity, lowers computational overhead, and enables real-time operation under vehicle compute constraints while maintaining accurate object trajectories. In some embodiments, detection and tracking are decoupled such that object embeddings are generated independently of track association, and a learnable association stage operates on object embeddings and prior track queries to update track state. This separation allows each component to be optimized for its specific technical function and further improves tracking accuracy and efficiency in multi-sensor, multi-object driving scenarios.

In some embodiments, the tracks generated by the transformer-based machine learning tracker are provided to one or more vehicle control systems to support operational decision-making by the vehicle. For example, tracked object states, including position, velocity, acceleration, and predicted future location, may be used by an autonomy control module, advanced driver assistance system (ADAS), or safety module to determine collision risk, generate alerts, or select control actions such as braking, steering, or torque modulation. By supplying temporally consistent object tracks derived from fused multi-modal sensor embeddings, the disclosed systems enable vehicle control decisions to be based on stable, physically grounded representations of the surrounding environment rather than frame-by-frame detections.

In some embodiments, the generated object tracks are further used as inputs to a path planning or motion planning module of the vehicle. The path planning module may evaluate predicted trajectories of tracked objects to determine a drivable corridor, select a planned path that avoids obstacles, or adjust a planned maneuver based on anticipated object motion. By providing temporally coherent tracks that incorporate information from multiple sensing modalities and prior time steps, the disclosed architecture improves the reliability of motion planning decisions in dynamic environments, including scenarios involving occlusion, overlapping sensor fields of view, or rapidly changing object motion.

In some embodiments, the disclosed systems are configured to operate under real-time constraints imposed by on-vehicle compute platforms. The reuse of BEV embeddings and encoded track state from preceding time steps reduces computational overhead associated with repeated object-to-track association and enables low-latency inference suitable for real-time vehicle operation. This allows the perception and tracking outputs to be generated at a rate sufficient to support time-critical safety functions, such as collision avoidance and emergency braking, during vehicle operation.

In some embodiments, tracking outputs may also be provided to a human-machine interface to present visualizations or alerts to a driver. Such outputs may include bounding boxes, trajectories, or warnings associated with tracked objects. However, the disclosed systems are not limited to visualization and are configured to support automated vehicle operation and control as described herein.

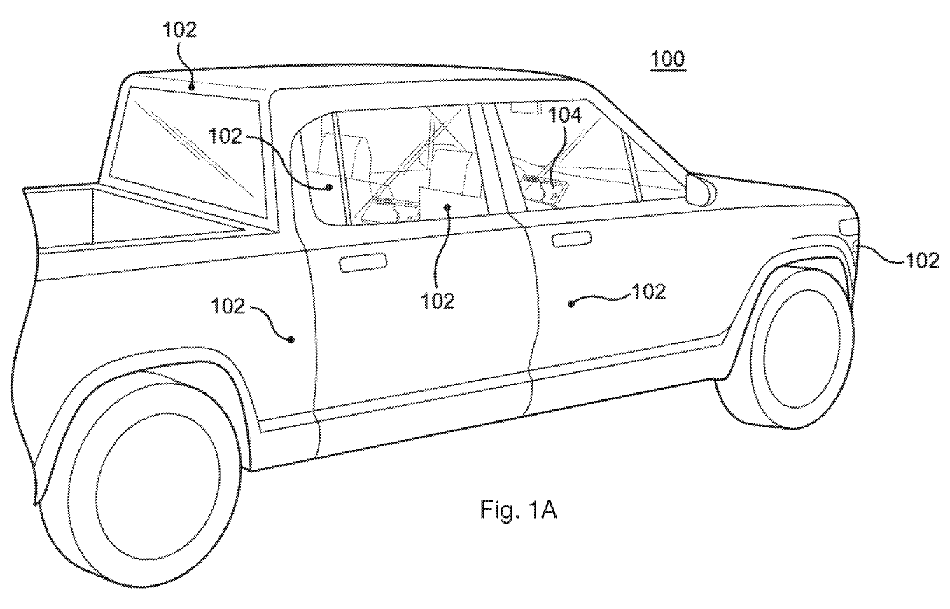

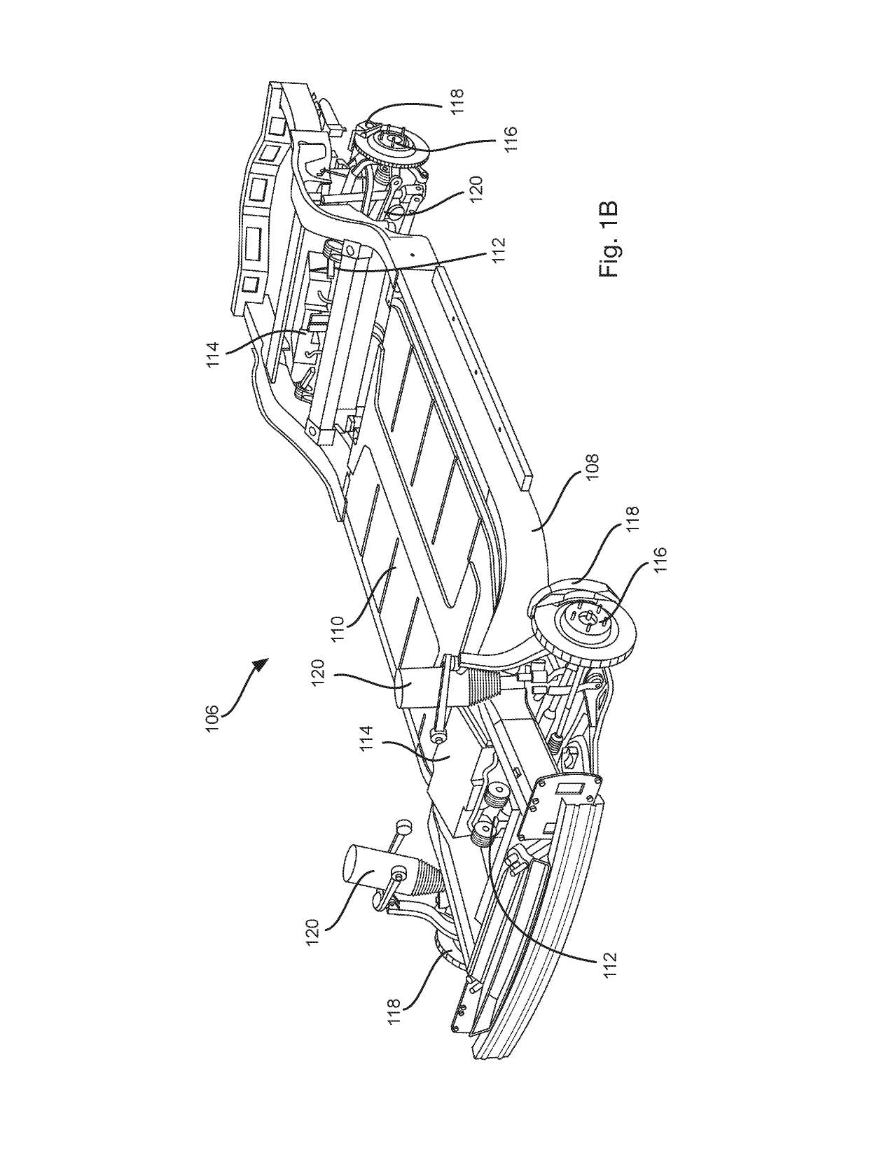

FIG. 1A illustrates an example vehicle 100. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (i.e., unibody construction).

In embodiments where the vehicle 100 is a battery electric vehicle or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear reduction drive. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by one or more sets of power electronics 114. The power electronics 114 may include inverters configured to convert direct current (DC) from the battery 110 into alternating current (AC) supplied to the motors of the drive units 112.

The drive units 112 are coupled to two or more hubs 116 to which wheels may mount. Each hub 116 includes a corresponding brake 118, such as the illustrated disc brakes. The drive units 112 or other component may also provide regenerative braking. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIG. 1B and in the discussion below, the vehicle 100 is a battery electric vehicle. However, the systems and methods disclosed herein may be used for any type of vehicle, including vehicles powered by an internal combustion engine (ICE), hybrid drivetrain, hydrogen fuel cell drivetrain, or other type of drivetrain that requires heating in preparation for use, such as diesel engines.

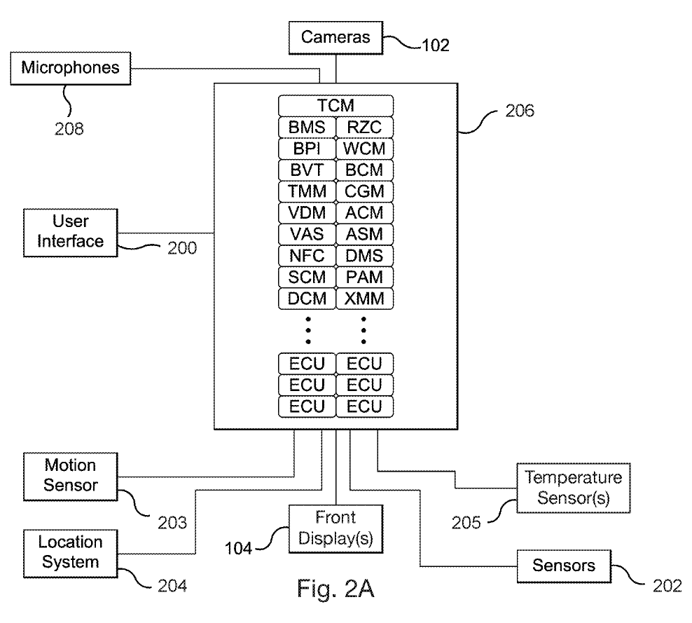

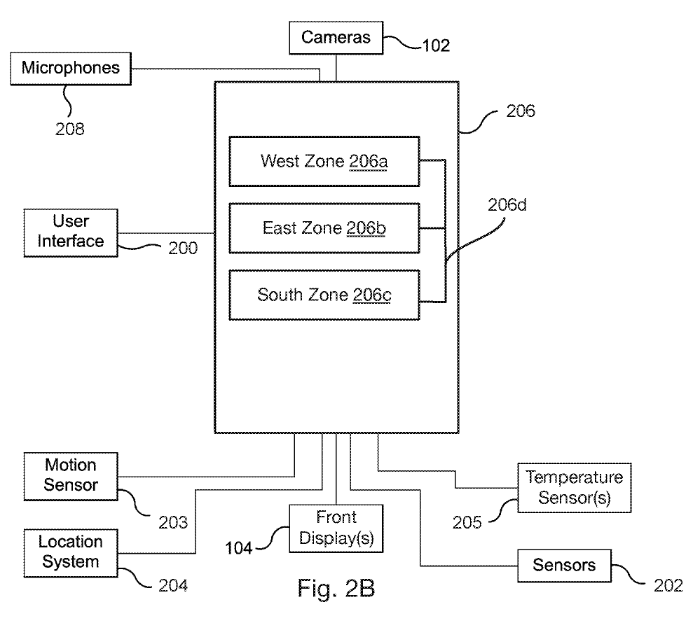

FIG. 2A illustrates example components of the vehicle 100 of FIG. 1A. As shown in FIG. 2A, the vehicle 100 includes the cameras 102, the one or more front displays 104, a user interface 200, one or more sensors 202, a motion sensor 203, and a location system 204. The one or more sensors 202 may include ultrasonic sensors, radio detection and ranging (RADAR) sensors, light detection and ranging (LIDAR) sensors, or other types of sensors. The location system 204 may be implemented as a global positioning system (GPS) receiver and may also include an inertial measurement unit (IMU) (e.g., accelerometers). The user interface 200 allows a user, such as a driver or passenger in the vehicle 100, to provide input.

The components of the vehicle 100 may include one or more temperature sensors 205. The temperature sensors 205 may include sensors configured to sense an ambient air temperature, temperature of the battery 110, temperature of power electronics 114, temperature of each drive unit 112 and/or each motor of each drive unit 112, or the temperature of any other component of the vehicle 100.

A control system 206 executes instructions to perform at least some of the actions or functions of the vehicle 100, including the functions described below. For example, as shown in FIG. 2, the control system 206 may include one or more electronic control units (ECUs) configured to perform at least some of the actions or functions of the vehicle 100, including the functions described below. In certain embodiments, each of the ECUs is dedicated to a specific set of functions. Each ECU may be a computer system and each ECU may include functionality described below.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle’s communications hub that connects and transfer data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102 and sensors 202. The sensor signals collected by the CGM ECU are then communicated to the appropriate ECUs for performing, for example, the operations and functions described below.

The control system 206 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU. If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 208, etc.) to the TCM ECU.

Referring to FIG. 2B, in some embodiments, the control system 206 may be implemented as a plurality of zonal controllers 206a, 206b, 206c. Each zonal controller 206a, 206b, 206c may control a subset of systems of the vehicle. The subset of systems controlled by each zonal controller 206a, 206b, 206c may be generally assigned based on location within the vehicle 100. For example, a west zonal controller 206a may control systems on a driver side of the vehicle 100, an east zonal controller 206b may control systems on a passenger side of the vehicle 100, and a south zonal controller 206c may control systems in a rear portion of the vehicle. Each zonal controller 206a, 206b, 206c may implement a portion of the functions ascribed to the ECUs of the control system 206 of FIG. 2A. The functions of the ECUs may be distributed among the zonal controller 206a, 206b, 206c such that only one zonal controller 206a, 206b, 206c implements the functions of each ECU. Alternatively, the functions of an ECU may be duplicated across multiple zonal controllers 206a, 206b, 206c, each zonal performing the functions of the ECU for the portion of the vehicle to which that zonal controller 206a, 206b, 206c is assigned.

The zonal controllers 206a, 206b, 206c may be connected to one another by a network 206d, such as an Ethernet network, controller area network (CAN), or other type of network.

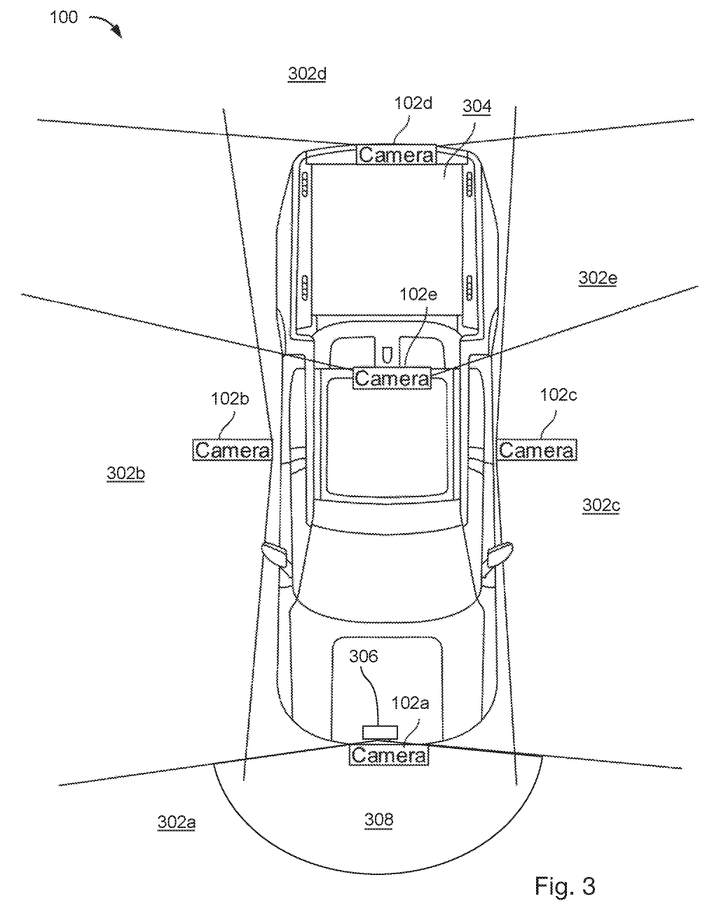

Referring to FIG. 3, the cameras 102 may be implemented as the illustrated cameras 102a-102e each having a corresponding field of view. As is apparent in FIG. 3, the fields of view of two or more cameras 102a-102e may overlap. For example, rear facing camera 102e having a bed 304 of the vehicle 100 in a field of view thereof may have a field of view 302e that overlap with the field of view 302d of another rear facing camera 102d, such as one mounted to a tailgate. As another example, side facing cameras 102b, 102c may have fields of view that overlap the fields of view 302a, 302d, 302e of both a front facing camera 102a and one or both rear facing cameras 102d, 102e. The illustrated configuration of the cameras 102a, 102e is exemplary only and any configuration of cameras may be used according to the examples disclosed herein.

The vehicle 100 may include one or more other sensors having different sensing modalities than the cameras 102a-102e, such as one or more radar sensors 306 each having a corresponding field of view 308. There may be multiple radar sensors 306 having multiple different fields of views. For example, different radar sensors 306 may have different ranges with the angular extent of the field of view 308 of a radar sensor 306 decreasing with increasing range. As is apparent, the field of view 308 of a radar sensor 306 may overlap the fields of view 302a, 302b, 302c of one or more cameras 102a, 102b, 102c. The illustrated configuration of the radar sensors 306 is exemplary only and other configurations are possible, such as one or more rear- or side-facing radar sensors 306.

Other sensors may also be used such as a light detection and ranging (LIDAR) sensors, ultrasonic sensors, or the like. Other sensors, such as a global positioning (GPS) system, inertial measurement unit (IMU), or the like may provide environmental data.

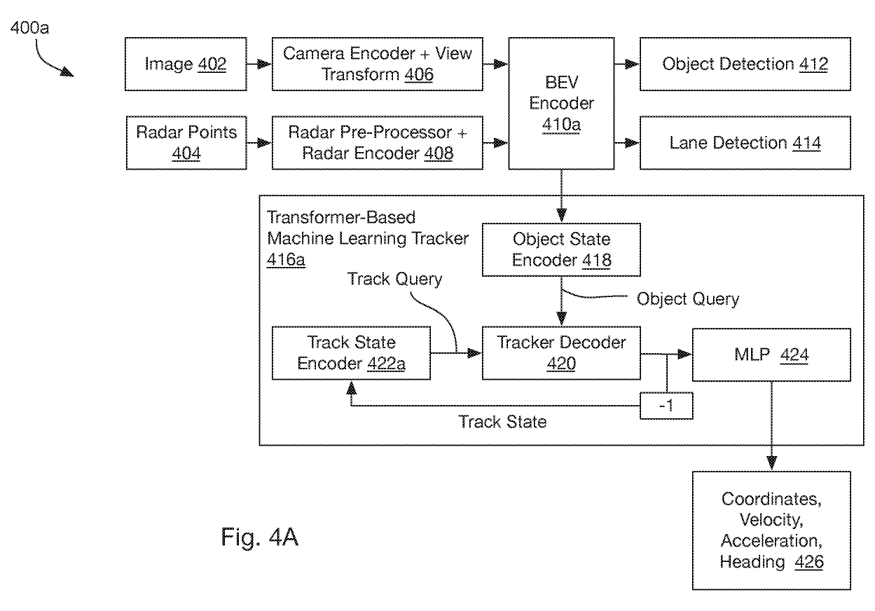

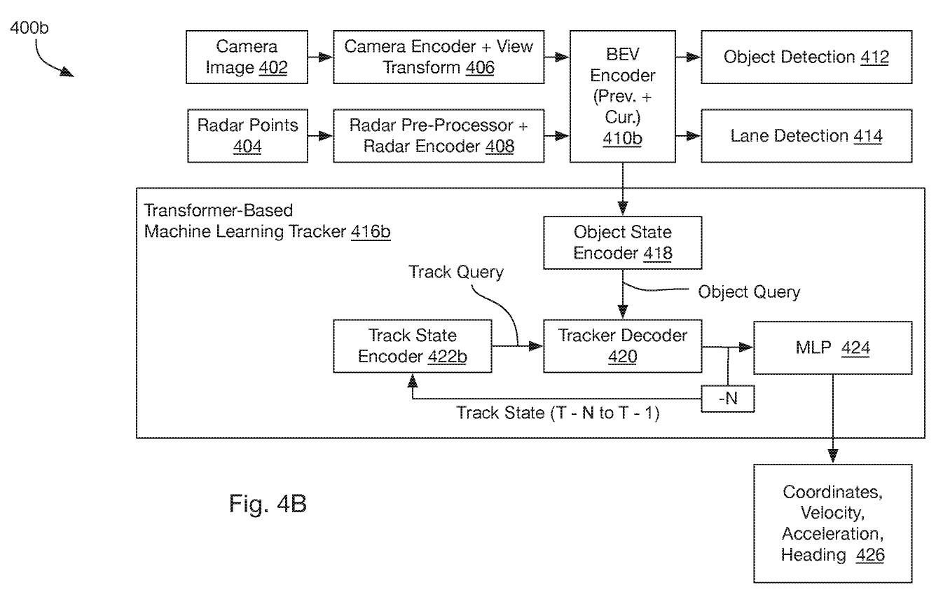

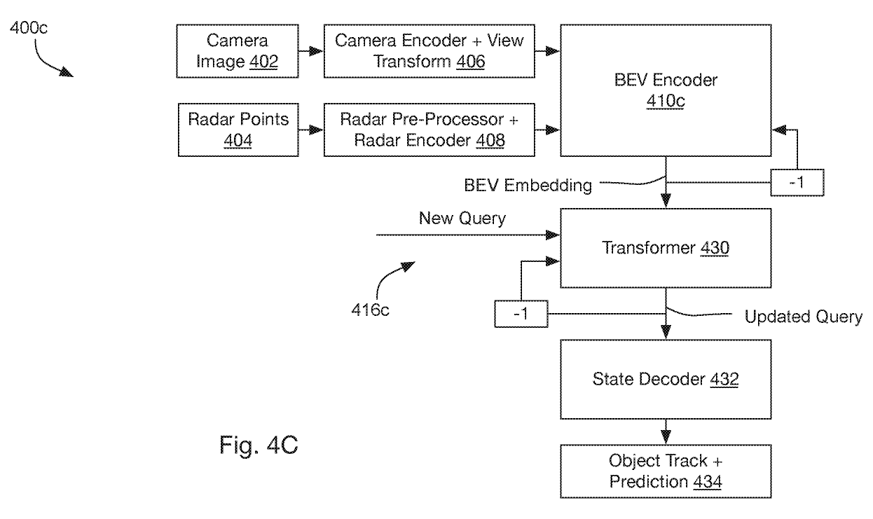

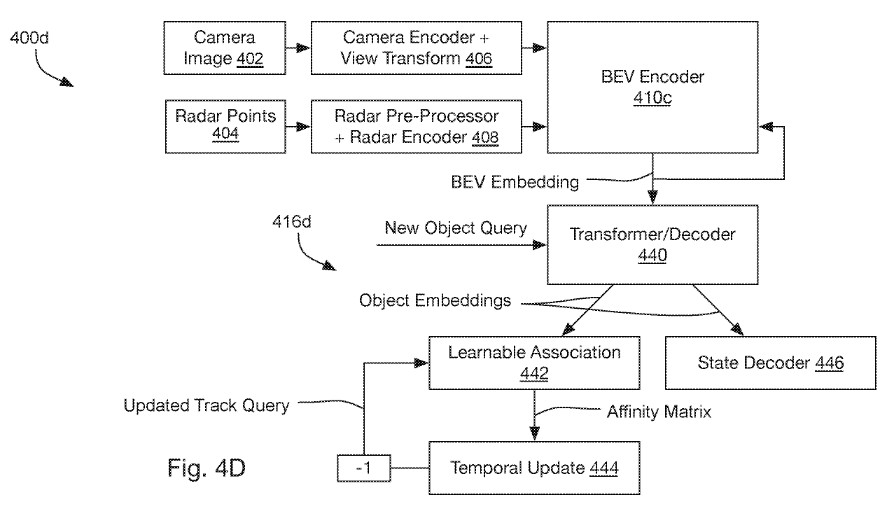

Referring to FIGS. 4A to 4D, the outputs of multiple sensors having multiple sensing modalities may be processed in combination using a machine learning model using a transformer and queries to perform object detection and tracking, which may include predicting a future location of an object. In the illustrated examples, one or more camera images 402 and radar points 404 from one or more radar sensors are processed for each time step. However, any number of sensor outputs according to any number of sensing modalities may be processed in a like manner.

Referring specifically to FIG. 4A, a system 400a may receive one or more camera images 402 from one or more cameras 102a-102d and radar points 404 from one or more radar sensors 306. Each image 402 may be processed using a camera encoder and birds-eye view (BEV) transform stage 406 (“stage 406”). There may be a separate stage 406 for each camera 102a-102d, e.g., the processing of stage 406 may be performed separately for each image 402 each of the one or more cameras 102a, 102d for a given time step. Stage 406 may perform an encoding step whereby features represented in an image are converted to image embeddings, e.g., an array of values containing information encoding features represented in the image. “Embeddings” as used herein and elsewhere may be understood as referring to non-human intelligible data output by an intermediate layer of a machine learning model and that is then used by a subsequent machine learning stage to perform a task. Stage 406 may additionally perform a coordinate transformation, such as from a two-dimensional coordinate system of an image 402 to a three-dimensional coordinate system defined with respect to the vehicle. The three-dimensional coordinate system may be a BEV coordinate system in which X and Y directions are defined in a horizontal plane of the vehicle, e.g., perpendicular to the direction of gravity when the vehicle 100 is level and a Z direction perpendicular to the X and Y directions. The origin of the BEV coordinate system may be located at a point on the vehicle 100.

Stage 406 may be implemented using a combination of a residual neural network (ResNet) feature extractor and a Lift-Splat-Shoot (LSS) feature pyramid network (FPN). ResNet may extract camera embeddings, and LSS, using a view transformer such as LSSTransformer, may project these features into the BEV coordinate system to obtain the BEV embeddings.

The system 400a may include a radar pre-processor and radar encoder stage 408 (“stage 408”). Stage 408 may process radar points 404 from a radar sensor of one or more radar sensors 306. There may be a separate stage 408 for each radar sensor 306, e.g., the processing of stage 408 may be performed separately for each set of radar points 404 from each of the one or more radar sensors 306 for a given time step. Stage 408 may perform pre-processing in the sense that radar points 404 may include labeling groups of radar points (or regions of space including groups of radar points) as corresponding to an object and possibly classifying the object. Stage 408 may perform encoding. As defined above, encoding may include generating radar embeddings encoding information included in the radar points 404, e.g., the objects (and possibly object classification) obtained from pre-processing. Stage 408 may be implemented using a voxelizer and a radar encoder, such as PointPillar, which organizes radar points 404 into vertical (e.g., Z direction in the BEV coordinate system) columns and processes the columns to obtain an encoding of features represented in the radar points.

Stages 406 and stage 408 may be parts of another machine learning model trained to perform task with the output of an intermediate stage (e.g., not the final output) of the machine learning model being used as the embeddings output by the stage 406, 408. For example, stages 406, 408 may be trained to translate information contained in the inputs into the BEV coordinate system. For example, stage 406 may be part of a machine learning model trained to attempt to generate a BEV image in the BEV coordinate system from an image 402. The output of stage 406 may therefore be an output of an intermediate layer of that machine learning model that is an array of values containing sufficient information to be processed by one or more subsequent layers of the machine learning model to obtain the final output of the machine learning model.

Stage 408 may be part of a machine learning model trained to segment and/or classify the radar points 404 as corresponding to specific objects and output a segmented set of points and possibly classifications for each segment. The output of stage 408 may therefore be an output of an intermediate layer of that machine learning model that is an array of values containing sufficient information to be processed by one or more subsequent layers of the machine learning model to obtain the final output of the machine learning model.

The output of stages 406, 408 may be image embeddings for each image 402 for a time step and radar embeddings for each set of radar points 404 for the time step. The image embeddings and radar embeddings may be input to a BEV encoder 410a. The BEV encoder 410a may be a machine learning model trained to fuse the image embeddings and radar embeddings to generate a unified BEV representation of information encoded in the image embeddings and the radar embeddings. The output of the BEV encoder 410a may be a three-dimensional scene in the BEV coordinate system, the scene including objects represented in the one or more images 402 and the one or more sets of radar points 404. The BEV encoder 410a may be trained to combine information in the one or more images 402 and one or more sets of radar points 404 into a single scene, e.g., such that a representation of an object in the scene is a composite of information in the one or more images 402 and the one or more sets of radar points 404.

The output of the BEV encoder 410a may be used for various purposes, such as by an object detection stage 412 and a lane detection stage 414 or any other purpose known in the art. Other possible purposes may include detecting whether a lane is occupied. A BEV embedding output of the BEV encoder 410a may also be processed as described below in order to perform object detection and tracking. The BEV embedding may be an output of an intermediate layer of the machine learning model implementing the BEV encoder, e.g., an array of values containing sufficient information to generate the output of the machine learning model but not the output of the final stage of the machine learning model that produces a human intelligible output (e.g., the three-dimensional scene).

The BEV embedding may be further processed by a transformer-based machine learning tracker 416a (“tracker 416a”) in order to generate tracks representing relative movement of objects over time, e.g., the objects represented in images 402 and sets of radar points 404 received at various time steps.

The tracker 416a may include an object state encoder 418 that receives the BEV embedding for a time step, e.g., generated from the one or more images 402 and one or more sets of radar points 404 for the time step. The object state encoder 418 may be a machine learning model trained to process the BEV embedding and output a more structured representation of objects represented in the one or more images 402 and one or more sets of radar points 404 for the time step. For example, the object state encoder 418 may output a listing of bounding blocks including each object detected in the BEV embedding. A bounding block may be represented as a pair of three-dimensional coordinates in the BEV coordinate system representing diagonally opposed corners of the bounding block or other representation.

The object state encoder 418 may output the structured representation of the objects in the form of an object query. An object query may be understood as specifying a region in space (e.g., the BEV coordinate space) to be evaluated by another machine learning model. The object query may include a human-intelligible representation or a non-human intelligible representation that encodes the regions in space occupied by the objects.

The object query may be input to a tracker decoder 420 along with a track query. The tracker decoder 420 is a machine learning model trained to process the object query and track query in order to obtain a current set of tracks. For example, for each object of a plurality of objects represented in the object query, a track followed by that object over time may be estimated by the tracker decoder 420 and included in the current set of tracks. Objects that are detected for a time step that are not matched to a track may be represented as a track with only one time step in the output of the tracker decoder 420.

The track query may be generated by a track state encoder 422a. The track state encoder 422a may be a machine learning model that receives an output of the tracker decoder 420, e.g., a set of tracks, from a previous time step and generates an encoding of information in the output, e.g., a representation of the set of tracks from the previous time step. In particular, the encoding may be a track query that indicates, to the tracker decoder 420, regions in space occupied by the objects of the set of tracks over one or more time steps for which each of the objects is represented in the set of tracks. The track query therefore functions to instruct the tracker decoder 420 to focus on these regions of space and to portions of the machine learning model implementing the tracker decoder 420 relating to these regions of space.

The tracker decoder 420 may perform track detection based on the object query from the object state encoder 418 for a time step and the output of the track state encoder 422a for the time step to obtain a track state for the current time step. For example, the tracker decoder 420 may assign objects represented in the object query with tracks represented in the track query to obtain the track state, e.g., tracks updated based on the position of the objects associated therewith for the current timestep.

The track state encoder 422a may be implemented as a machine learning model that uses self-attention mechanisms to process historical track embeddings and cross-attention mechanisms to incorporate contextual information from additional sources. The track state encoder 422a may take, as an input, the track state output by the tracker decoder 420 for a previous time step and output a new track query for the current time step. The new track query may be derived from the track state and may represent the region in space occupied by objects detected in the track state. The new track query may define a set of regions and possibly a set of features for each region to be used by the tracker decoder 420 to perform object detection and tracking.

The track state may be processed by a multi-layer perceptron (MLP) stage 424. The MLP stage 424 may output tracking data 426, such as coordinates defining bounding boxes for the current location of objects indicated in the track state, such as in the BEV coordinate system. The tracking data 426 may include data derived from tracks of objects, such as velocity, acceleration, heading, or other information, such as a predicted future location based on the track data.

Referring to FIG. 4B, in an alternative embodiment, a system 400b may incorporate more temporal information. In the system 400b, like-numbered elements with the system 400a may function as described above.

In the system 400b, the BEV encoder 410b may function as described above except that the BEV processes the outputs of stages 406 and 408 for the current time step and one or more previous time steps. Stated differently, for each camera 102a-102d for which images 402 are processed, the BEV encoder 410b may process the image embeddings of the stage 406 resulting from processing both of the image 402 for the current time step and at least one previous time step. Likewise, for each radar sensor 306, the BEV encoder 410b may process the radar embeddings of stage 408 for both of the set of radar points 404 for the current time step and at least one previous time step 6.

The system 400b may include a transformer-based machine learning tracker 416b (“tracker 416b”) that may function the same as the tracker 416a except that the tracker 416b includes a track state encoder 422b that processes track states for N time steps preceding the current time step, where N is a value of 1 or greater, such as 8, 9, 10, or higher. For example, where the current time step is for time T, the track state encoder 422b may process track states for time steps T – N to T -1.

FIG. 4C illustrates an alternative system 400c. In the system 400c, like-numbered elements with the system 400a may function as described above.

In the system 400c, the outputs of the stages 406, 408 may be input to a BEV encoder 410c that implements the functions of either of the BEV encoders 410a, 410b described above. In addition, the BEV encoder may take, as an input, the BEV embeddings output by the BEV encoder 410c for a previous time step. The BEV encoder 410c may be implemented as a temporal BEV encoder that uses temporal attention and spatial attention to fuse the BEV embeddings from a previous time step with the outputs of the stages 406, 408 for the current time step to obtain the BEV embeddings for the current time step.

The BEV embeddings from the BEV encoder 410c may be input to a transformer-based machine learning tracker 416c (“tracker 416c”) including a transformer 430. The transformer 430 may implement the three-dimensional MUlti-camera Tracking (MUTR3D) framework, such that a track query directly models three-dimensional states and appearance features of an object track over time and across multiple sensors (e.g., multiple cameras 102a-102d and/or multiple radar sensors 306). The MUTR3D framework provides a transformer-based architecture that can be used to enhance the BEV data to improve the performance of detection and tracking tasks. This approach leverages the strengths of transformers in capturing long-range dependencies and complex spatial relationships, which improves accuracy and robustness in dynamic environments. This architecture may be extended to different sensing modalities and tasks, such as performing behavior prediction.

The updated query may be input to a state decoder 432 of the tracker 416c. The updated query may be encoded, e.g., a type of embedding that is not human intelligible but that contains information to extract the locations of objects represented in the images 402 and radar points 404. The state decoder 432 may therefore be a machine learning model trained to extract human-intelligible data from the updated query. Since the updated query is based on the BEV embedding for the current time step and the updated query from a previous time step, the updated query may include temporal information, e.g., historical positions of objects represented in the updated query as well as the current position of the objects. The state decoder 432 may be trained to output a track 434 for each object of a plurality of objects represented in the updated query. The track 434 may include, for each object, a current position, one or past positions of the object, and possibly one or more predicted positions for the object. Positions of the object included in the track may be represented as three-dimensional bounding boxes.

FIG. 4D illustrates an alternative system 400d. In the system 400d, like-numbered elements with the system 400a and/or 400c may function as described above.

In the system 400d, the BEV embedding may be input to a transformer/decoder 440 of a transformer-based machine learning tracker 416d (“tracker 416d”). The transformer/decoder 440 may further receive a new object query as defined above with respect to the system 400c. The transformer/decoder 440 may be a machine learning model trained to process the BEV embedding and any new object query to detect objects represented in the BEV embedding with attention to regions of space indicated in the new object query. The new object query may be as defined above with respect to the system 400c.

The transformer/decoder 440 may output object embeddings that encode the position and features of objects represented in the BEV embedding, the object embeddings being generated with attention according to the new object query. The object embeddings may include representations of detected objects, including the location and possibly features (e.g., color, context, other visual attributes) of the detected objects and/or tracks. In some embodiments, the transformer/decoder 440 is a transformer/decoder according to the DQTrack framework.

The object embeddings may be input to a learnable association stage 442 of the tracker 416d. The learnable association stage 442 may include a machine learning model trained to represent the association between objects and the trajectories of objects, e.g., tracks. For example, the learnable association stage 442 may be trained to output an affinity matrix for a current time step. The learnable association stage 442 may take, as an input, an updated track query generated by a temporal update stage 444 of the tracker 416d for the previous time step. The learnable association stage 442 may therefore be understood as estimating an affinity of an object represented in the object embeddings and objects represented in the updated track query for the preceding time step. The affinity matrix as output by the learnable association stage 442 may therefore be a matrix that records, for each pair of objects represented thereby (e.g., represented in the object embeddings and detected in previous time steps) an affinity between the pair of objects. In some embodiments, the learnable association stage 442 and the affinity matrix are defined according to the DQTrack framework.

A temporal update stage 444 may receive the affinity matrix and output an updated track query for use in a subsequent timestep. The temporal update stage 444 may be a machine learning model trained to generate a track based on the affinity matrix. The temporal update stage 444 may use the affinity matrix to determine track-object pairs, such as by integrating detected objects with existing tracks, generated updated trajectories, and generating an output track query based on the trajectories. The temporal update stage 444 may use information in the affinity matrix to update appearance and geometry information associated with the track of an object, e.g. according to the current affinity matrix, which includes features of an object added to a track by the learnable association stage 442 to facilitate associating objects with the track in subsequent time steps.

Detected objects and/or tracks may be input to a state decoder 446 of the tracker 416d. The state decoder 446 may be a machine learning model trained to extract human-intelligible data from the object embeddings. Since state decoder 446 receives BEV embedding based on the current time step and the BEV embeddings of the previous time step, the state decoder 446 may be enabled to extract temporal information. For example, the state decoder 446 may be trained to output tracks for one or more objects or other data derived from tracks of objects, such as velocity, acceleration, heading, or other information, such as a predicted future location based on the track data.

In the system 400c, there is a decoupling between the generation and processing of object detection queries (the function of the transformer/decoder 440) and the generation and processing of tracks (the function of the learnable association stage 442 and the temporal update stage 444). This separation allows for specialized processing tailored to the specific needs of detection and tracking tasks, leading to more accurate and efficient inferences. This architecture is may also be extended, such as to perform predict future behavior of objects or other specialized tasks.

The systems 400a, 400b, 400c, 400d may be trained using any approach known in the art. Components of the system 400a, 400b, 400c, 400d may be trained individually followed by training as a system 400a, 400b, 400c, 400d. Training data may include human labeled data, e.g., sets of images and radar points for a plurality of time steps labeled with the location of objects and tracks of objects represented in the sets of images and radar points. Training data may be augmented with automatically labelled data. For example, training may first be performed with a large learning rate using a large data set including automatically labeled data, and possibly human-labeled data, followed by fine tuning using exclusively human-labeled data.

Loss functions may be a function of detection loss, which may combine a level three-dimensional (L13D) bounding box loss and a classification focal loss. Loss functions may also be a function of tracking loss, such as using cross-entropy loss for predicting tracking associations and identity correspondence across frames.

Training of the systems 400a, 400b, 400c, 400d may use various optimization techniques and algorithms. These techniques collectively contribute to the stability and efficiency of the training process and ensure better generalization and performance of the model. The optimization techniques and algorithms may include some or all of: AdamW Optimizer: Applied for weight decay correction. Learning Rate Multipliers: Different learning rates are applied to various parts of the network. Gradient Clipping by Norm: Prevent exploding gradients. Gradient Accumulation: Simulate larger batch sizes. Validation Check Intervals: Ensures frequent performance monitoring during training.

Validation of the systems 400a, 400b, 400c, 400d may be implemented using a validation pipeline including metrics, validation sets, and performance monitoring. The metrics may include evaluating the model using both object detection metrics (e.g., mean average precision, max recall, intersection over union (IOU), average translation error, average orientation error) and tracking metrics (e.g., multiple object tracking accuracy (MOTA), multiple object tracking precision (MOTP), identify switches, velocity error, mostly tracked, mostly lost).

Diverse validation sets may be created and encompass various real-world driving scenarios to ensure the model generalizes well across different environments. Performance monitoring may include continuously monitoring validation performance to identify potential issues and iterate on the model and data collection strategies.

Testing of the systems 400a, 400b, 400c, 400d may be implemented using a testing pipeline. The testing pipeline may include a comprehensive set of test scenarios that cover edge cases and challenging situations not encountered during training. The testing pipeline may include real-time testing, which may include deploying the model on test vehicles to evaluate the model’s performance in real-world driving conditions, collect feedback, and iterate on the model to improve robustness and accuracy. Testing may include simulations, such as using driving simulators to test the model's performance in controlled environments where rare and dangerous scenarios can be safely evaluated.

The systems 400a, 400b, 400c, 400d may be optimized using various approaches to enable the model to run efficiently on the vehicle upon deployment. For example, model optimization may use Open Neural Network Exchange (ONNX) to convert models from different frameworks into a standardized format. This facilitates interoperability and allows for the application of various optimizations via ONNX Runtime to ensure efficient model inference. Tensor Real Time (TensorRT) may be used to further optimize the model. TensorRT performs layer fusion, precision calibration (e.g., 16-bit floating point (FP16), 8-bit integer (INT8)), and kernel auto-tuning, significantly improving inference speed and reducing latency.

Hardware acceleration may also be used in the vehicle 100 to accelerate obtaining inferences from the systems 400a, 400b, 400c, 400d. For example, a Compute Unified Device Architecture (CUDA) may be leveraged to harness the parallel processing power of graphics processing units (GPUs), such as NVIDIA GPUs. CUDA provides the computational foundation for running deep learning models efficiently, enabling the execution of complex operations at high speeds. TensorRT additionally accelerates inference by utilizing the capabilities of GPUs to ensure that the model runs with low latency and high throughput.

Fail safes and redundancy may be used to ensure the perception system remains reliable under various operational conditions. This includes designing the system to handle sensor failures, unexpected inputs, and other anomalies, ensuring continuous and safe operation of the vehicle.

Data obtained according to the approaches described above with respect to FIGS. 4A to 4D may be used to autonomously alter the trajectory of the vehicle 100, such as in order to autonomously drive the vehicle or to provide automated driver assistance. In particular, the data obtained may include tracking data 426 according to the systems 400a, 400b, a track 434 according to the system 400c, and/or tracks obtained from the state decoder 446 of the system 400d. For example, the data may be used to generate a path autonomously traversed by the vehicle 100, perform automated collision avoidance or to autonomously guide other evasive actions by the vehicle 100. The data may be used to generate alerts, such as in the form of information displayed on a front display 104. For example, a rendering of objects traversing actual or predicted paths indicated by the data may be displayed on the front display 104. The manner in which the data is used to perform autonomous driving, perform automated driver assistance, or driver alerts may be according to any approach known in the art.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a one or more computer processing devices. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Certain types of storage devices that include these mediums include: diskette, hard disk, random access memory (RAM), read only memory (ROM), erasable programmable read only memory (EPROM or Flash memory), static random access memory (SRAM), compact disc read only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, refers to non-transitory storage rather than transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but the storage device remains non-transitory during these processes because the data remains non-transitory while stored.

While the foregoing is directed to embodiments of the present disclosure, other and further embodiments may be devised without departing from the basic scope thereof, and the scope thereof is determined by the claims that follow.

What is claimed is:

1. A system comprising:
one or more first imaging sensors mounted to a vehicle and implementing a first imaging modality;
one or more second imaging sensors mounted to the vehicle and implementing a second imaging modality; and
a computing device configured to:
receive first imaging data from the one or more first imaging sensors;
receive second imaging data from the one or more second imaging sensors;
process the first imaging data with one or more first stages to transform the first imaging data into first embeddings in a common coordinate system;
process the second imaging data with one or more second stages to transform the second imaging data into second embeddings in the common coordinate system; and
fuse the first embeddings and the second embeddings with an encoder to obtain third embeddings representing a 3D scene including objects represented in first and second imaging data.

2. The system of claim 1, wherein the one or more first imaging sensors include one or more cameras.

3. The system of claim 2, wherein the one or more cameras include a plurality of cameras, and wherein processing the first imaging data with the one or more first stages comprises separately processing an image from each camera of the plurality of cameras using a stage of the one or more first stages.

4. The system of claim 1, wherein the one or more second imaging sensors include one or more radar sensors.

5. The system of claim 4, wherein the one or more radar sensors include a plurality of radar sensors, and wherein processing the second imaging data with the one or more second stages comprises separately processing a set of radar points from each radar sensor of the plurality of radar sensors using a stage of the one or more second stages.

6. The system of claim 1, wherein fusing the first embeddings and the second embeddings with the encoder to obtain the third embeddings comprises processing the first embeddings and the second embeddings for a current time step along with the third embeddings for one or more prior time steps.

7. The system of claim 1, wherein the common coordinate system is one in which X and Y directions are defined in a horizontal plane of the vehicle and a Z direction is perpendicular to the X and Y directions.

8. The system of claim 1, wherein the one or more first stages include a combination of a residual neural network (ResNet) feature extractor and a Lift-Splat-Shoot (LSS) feature pyramid network (FPN).

9. The system of claim 1, wherein the encoder is configured to process the first and second embeddings for a current time step and for at least one preceding time step.

10. The system of claim 1, wherein the computing device is further configured to process the third embeddings with a transformer-based machine learning tracker to obtain tracks for one or more objects represented in the first imaging data and the second imaging data.

11. A method comprising:
receiving, by a computing device, first imaging data from one or more first imaging sensors;
receiving, by the computing device, second imaging data from one or more second imaging sensors;
processing, by the computing device, the first imaging data with one or more first stages to transform the first imaging data into first embeddings in a common coordinate system;
processing, by the computing device, the second imaging data with one or more second stages to transform the second imaging data into second embeddings in the common coordinate system;
fusing, by the computing device, the first embeddings and the second embeddings with an encoder to obtain third embeddings; and
processing, by the computing device, the third embeddings with a transformer-based machine learning tracker to obtain tracks for one or more objects represented in the first imaging data and the second imaging data.

12. The method of claim 11, further comprising:
generating, by the transformer-based machine learning tracker, a query for each time step; and
processing, by the transformer-based machine learning tracker, as an input for a time step, the query for a preceding time step.

13. The method of claim 11, further comprising decoupling, by the transformer-based machine learning tracker, object identification for the one or more objects from obtaining the tracks for the one or more objects.

14. The method of claim 11, wherein the transformer-based machine learning tracker implements three-dimensional multi-camera tracking (MUTR3D).

15. The method of claim 11, wherein the transformer-based machine learning tracker implements a DQTrack framework.

16. The method of claim 11, wherein processing the third embeddings with the transformer-based machine learning tracker comprises:
generating a track state for a current time step by the transformer-based machine learning tracker based on a track state from one or more preceding time steps and the third embeddings; and
processing the track state of the current time step to obtain the tracks.

17. The method of claim 16, wherein fusing the first embeddings and the second embeddings with the encoder to obtain the third embeddings comprises processing the first embeddings and the second embeddings for the current time step with the third embeddings for the one or more preceding time steps.

18. A system comprising:
one or more first imaging sensors mounted to a vehicle and implementing a first imaging modality;
one or more second imaging sensors mounted to the vehicle and implementing a second imaging modality; and
a computing device configured to:
receive first imaging data from the one or more first imaging sensors;
receive second imaging data from the one or more second imaging sensors;
process the first imaging data with one or more first stages to transform the first imaging data into first embeddings in a common coordinate system;
process the second imaging data with one or more second stages to transform the second imaging data into second embeddings in the common coordinate system;
process the first embeddings and the second embeddings to obtain tracks for one or more objects represented in the first imaging data and the second imaging data; and
autonomously altering a trajectory of the vehicle according to the tracks.

19. The system of claim 18, wherein the one or more first imaging sensors include a plurality of cameras, and wherein processing the first imaging data with the one or more first stages comprises separately processing an image from each camera of the plurality of cameras using a stage of the one or more first stages.

20. The system of claim 18, wherein the one or more second imaging sensors include one or more radar sensors.
